(19) United States
(12) Patent Application Publication
(10) Pub. No.: US 2014/0326448 A1
(43) Pub. Date: Nov. 6, 2014

(54) FLEXIBLE CONNECTIONS

(71) Applicant: Cain Pacheco, Houston, TX (US)

(72) Inventor: Cain Pacheco, Houston, TX (US)

(21) Appl. No.: 13/871,619

(22) Filed: Apr. 26, 2013

Related U.S. Application Data
(60) Provisional application No. 61/639,448, filed on Apr. 27, 2012.

(51) Int. Cl. F16L 15/06

(52) U.S. Cl. CPC F16L 15/06
USPC 166/242.6; 285/334

(57) ABSTRACT

A double shoulder threaded tool joint connection comprising: a pin with external threads formed between a pin external shoulder and a pin internal shoulder, the pin having a nose section between the pin internal shoulder and the pin external threads; a box with internal threads formed between a box external shoulder and a box internal shoulder; wherein the internal threads and the external threads are arranged and designed for connection with each other so that the box and the pin are connected with a common center-line and with a primary seal formed by the pin external shoulder forced against the box external shoulder and a secondary seal formed between the pin internal shoulder forced again the box internal shoulder and wherein the internal threads and the external threads comprise: stab flanks having stab flank angles of between 20° and 40° measured from the thread axis and load flanks having first load flank angles of between 60° and 80° measured from the thread axis and second load flank angles of between 100° and 120° measured from the thread axis.

### CROSS-REFERENCE TO RELATED APPLICATION

This application is based upon and claims the benefit of priority from U.S. Provisional Application No. 61/639,448, filed on Apr. 27, 2012, the entire contents of which are incorporated herein by reference.

### BACKGROUND

Highly deviated drilling programs and horizontal wells are becoming widely used to access reservoirs. Due to the steep angle of these deviated wells, high bending stresses are induced in drill pipes that rotate within curved portions of the well. With these high bending stresses, the drill pipe connections may develop fatigue cracks at their thread roots. These fatigue cracks can lead to washouts or even failure. It has previously been established in conventional “V” threads that increasing the root radius of the thread form aids in the reduction of the connections' peak stresses. Most drill pipe manufactures are now designing connections to help in the reduction on the connection fatigue stresses by applying this method.

In developing these new connections by the above mentioned method, designers have to compromise with the reduction in torque and or tensile capacity of the connection due to the geometry of the connection, which is highly affected by the thread form design. In some cases, designers will have to undercut the threads to produce a larger root radius. These undercuts may further reduce the performance of the connection in torque and tensile capacity.

Taking in mind the above current design status of the drill pipe connections in the existing market, there is a need to develop a change in geometry evolving from the conventional “V” threads to achieve not only a high level of fatigue resistance to bending stresses, but also to achieve higher torque and tensile requirements within the given design area. In addition, it is also desirable to develop a threaded connection that forms a slim hole profile design in order to minimize the pressure loss within the well and to aid in the removal of cuttings and debris from the well.

### SUMMARY

The present invention relates to a threaded tool joint connections. More particularly, in certain embodiments, the present invention relates to threaded tool joint connections comprising multi-surface load flanks.

In one embodiment, the present invention provides a double shoulder threaded tool joint connection comprising: a pin with external threads formed between a pin external shoulder and a pin internal shoulder, the pin having a nose section between the pin internal shoulder and the pin external threads; a box with internal threads formed between a box external shoulder and a box internal shoulder; wherein the internal threads and the external threads are arranged and designed for connection with each other so that the box and the pin are connected with a common center-line and with a primary seal formed by the pin external shoulder forced against the box external shoulder and a secondary seal formed between the pin internal shoulder forced again the box internal shoulder and wherein the internal threads and the external threads comprise: stab flanks having stab flank angles of 30° measured from the thread axis and load flanks having first load flank angles of 70° measured from the thread axis and second load flank angles of 110° measured from the thread axis.

The features and advantages of the present invention will be readily apparent to those skilled in the art. While numerous changes may be made by those skilled in the art, such changes are within the spirit of the invention.

### BRIEF DESCRIPTION OF THE DRAWINGS

A more complete and thorough understanding of the present embodiments and advantages thereof may be acquired by referring to the following description taken in conjunction with the accompanying drawings.

FIG. 1 is an illustration of a drill pipe comprising an external mating shoulder in an internal mating shoulder in accordance with certain embodiments of the present disclosure.

FIG. 2 is an illustration of a partial view of the threaded connection of two joints in accordance with certain embodiments of the present disclosure.

FIG. 3 is a chart comparing the attributes of one embodiment of the flexible tool joint connection disclosed herein with several conventional tool joint connections.

FIG. 4 is an illustration of a drill pipe comprising a thread design in accordance with certain embodiments of the present disclosure.

FIG. 5 is an illustration of two drill pipes comprising thread designs in accordance with certain embodiments of the present disclosure.

FIG. 6 is an illustration of a thread design in accordance with certain embodiments of the present disclosure.

### DETAILED DESCRIPTION

The present invention relates to a threaded tool joint connections. More particularly, in certain embodiments, the present invention relates to threaded tool joint connections comprising multi-surface load flanks.

The current disclosure is aimed at evolving from a conventional “V” thread and moving on to a more “trapezoidal” thread form that will allow for larger root surface as well as keeping the connections' male and female members engaged at their critical load bearing contact areas while a bending moment is being applied to the tool joint connection. This design will also encompass high torsional and tensile capacity as well as reach a high level of fatigue cycles due to the geometry of the trapezoidal thread form, all while maintaining a slim hole geometry. The design may maintain minimal cross-sectional area at the connections critical design areas. The threaded connections discussed herein may have threads that will be on a taper and will have multiple leads/multiple starts, preferably two.

There may be several potential advantages of using the thread forms and threaded connections disclosed herein. One of the many potential advantages of the thread forms disclosed herein is that they may provide for multi-surface contact load flanks In certain embodiments, threaded tool joints comprising the thread forms disclosed herein are able to have interlocking load flanks because of the negative angles of the thread form. This, along with the radii on the stab flanks, allows the connection to interlock itself due to the push-off at the stab flank radii interference towards the load flanks.

Another potential advantage to the thread forms disclosed herein, is that they may provide for a large root radii. This is achieved based on the negative angles of the thread form the 2° angle on the stab flank and 20° angle on the load flank, this widens the thread form which allows for a very large root radius to be used.

The large root radii may increase the connections' critical cross-sectional area by not having such an undercut at the thread root. In certain embodiments, the thread forms disclosed herein may allow for a connection cross-section area that is less than 70% of the cross-section of the female tool joint's outer diameter and inner diameter. The distance from the design's pitch line to the root of the thread may be kept fairly small in comparison to most “V” threads, which allows for more metal between the connections outer diameter and inner diameter. Although the connections discussed herein may still have thick connections, the design's stiffness ratio is decreased making the connection more flexible than the present designs.

Another potential advantage to the thread forms disclosed herein, is that they may provide for large flank angles. This is achievable due to the load and stab flank angles having a negative degree from the vertical axis. For example, the stab flanks may have 60° angle from the vertical axis and the stab flank angle having a 20° angle from the vertical axis of the connection. This provides for an included angle of 40°.

Another potential advantage to the thread forms disclosed herein, is that they may provide for a two to three turn connection. This may be achieved by having a double lead thread design, a large number of threads per inch, or a combination of tapers ranging from 0.750″ to 1.125″. In certain embodiments, the threaded connections discussed herein may range from 2.09 turns to 3.22 turns.

Another potential advantage to the thread forms disclosed herein, is that they may provide for an increased torque capacity. The thread forms described herein may provide for a 10% to 150% increase in torque depending on the connection. The trapezoidal thread form allows for more load and stab flank engagement which helps with gaining more surface area for torque. This in turn allows for a shorter connection with the same shear strength to withstand any thread shear due to torque and also allow for the connection to remain engaged under severe bending moments or dog leg severities.

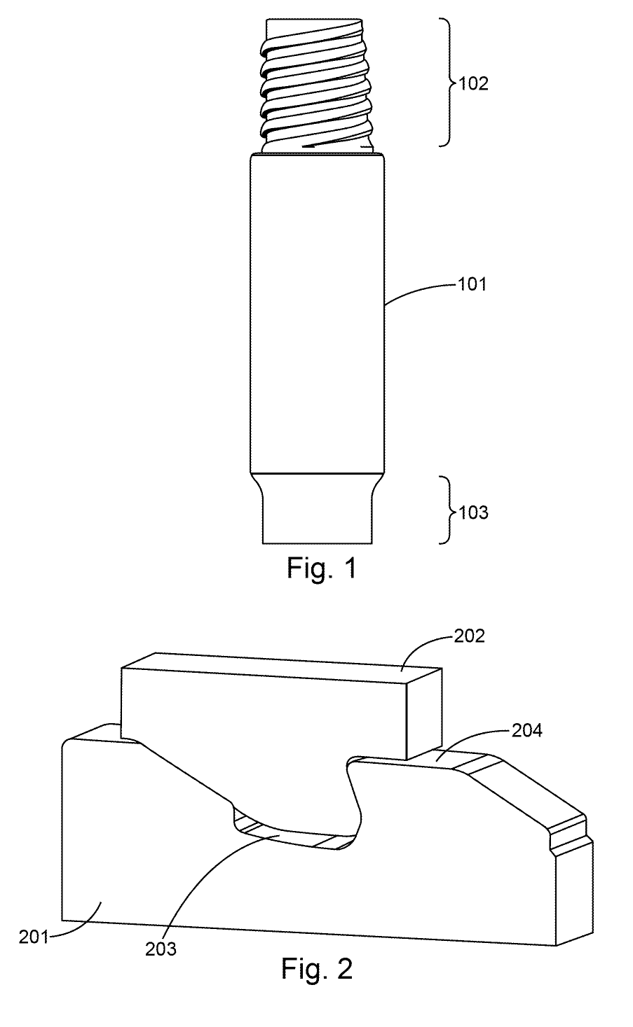

In certain embodiments, the present disclosure provides for a double shoulder tool joint connection, where the connection will have an external mating shoulder and an internal mating shoulder, this will aid in producing additional surface area for the higher torque requirements. FIG. 1 illustrates drill pipe 101 comprising an external mating shoulder 102 and an internal mating shoulder 103 with thread forms in accordance with certain embodiments of the present disclosure.

FIG. 2 illustrates a partial view of the threaded connection of two joints in accordance with certain embodiments of the present disclosure.

In certain embodiments, the thread forms of the present disclosure may comprise an external or male thread form 201 having a stab flank angle of from about 20° to about 40° from the thread axis. In certain embodiments, as shown in FIG. 2, the external or male thread form 201 may have a stab flank having an angle of 30° from the thread axis. In certain embodiments, the external or male thread form 201 may have a load flank angle of from about 60° to about 80° from the thread axis. In certain embodiments, as shown in FIG. 2, the external or male thread form 201 may have a load flank having an angle of 70° from the thread axis. Additionally, in certain embodiments, the load flank may encompass more surface area by having an additional positive flank angle which is equal, but opposite in direction of the first flank angle.

In certain embodiments, the thread forms of the present disclosure may comprise an internal or female thread form 202 having a stab flank angle of from about 20° to about 40° from the thread axis. In certain embodiments, as shown in FIG. 2, the internal or female thread form 202 may have a stab flank having an angle of 30° from the thread axis. In certain embodiments, the internal or female thread form 202 may have a load flank angle of from about 60° to about 80° from the thread axis. In certain embodiments, as shown in FIG. 2, the internal or female thread form 202 may have a load flank having an angle of 70° from the thread axis. Additionally, in certain embodiments, the load flank may encompass more surface area by having an additional positive flank angle which is equal, but opposite in direction of the first flank angle.

In certain embodiments, the thread form may have supplementary radii at all corners to reduce any stress risers that could occur due to the bending loads.

As shown in FIG. 2, when the tool joint is assembled, the thread root 203 and thread crest 204 will not be in engagement. The root surface will still have a small flat area that is parallel to the pitch line of the threads. The thread will have an undercut area that will help in increasing the root surface, but will not diminish the performance from the threaded connection.

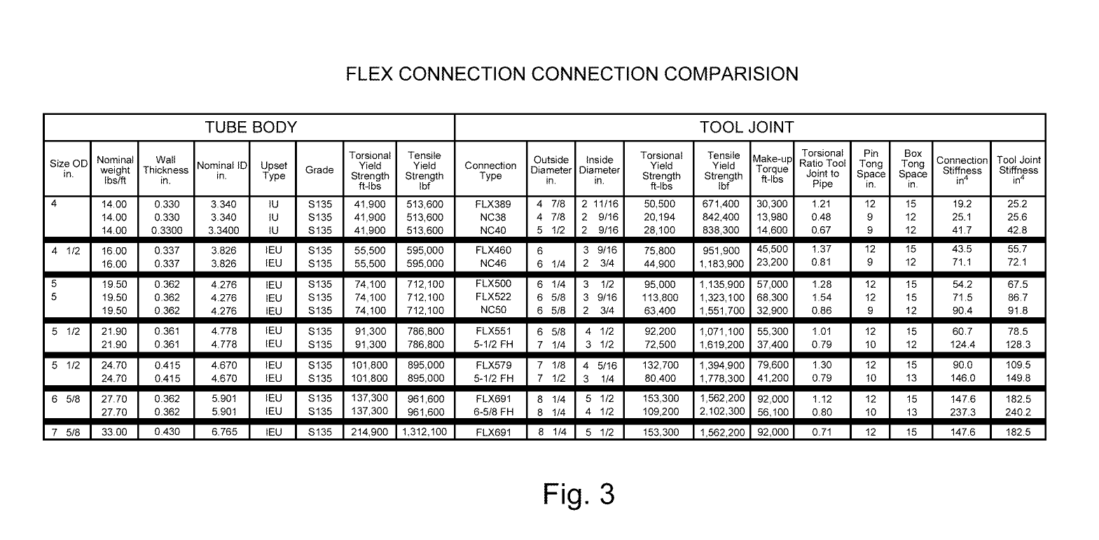

Referring now to FIG. 3, FIG. 3 illustrates a chart comparing the attributes of one embodiment of the flexible tool joint connection disclosed herein with several conventional tool joint connections.

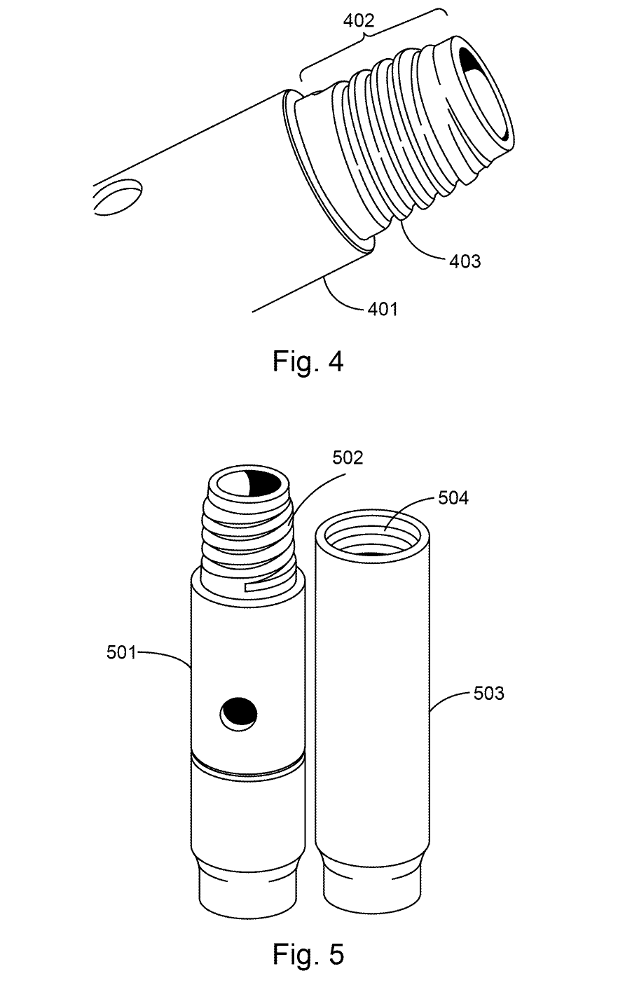

Referring now to FIG. 4, FIG. 4 illustrates drill pipe 401 comprising an external mating shoulder 402 with external or male thread form 403 in accordance with certain embodiments of the present disclosure.

Referring now to FIG. 5, FIG. 5 illustrates drill pipe 501 comprising external or male thread form 502 in accordance with certain embodiments of the present disclosure. FIG. 5 further illustrates drill pipe 503 comprising internal or female thread form 504, which is partially obscured by the external surface of drill pipe 503.

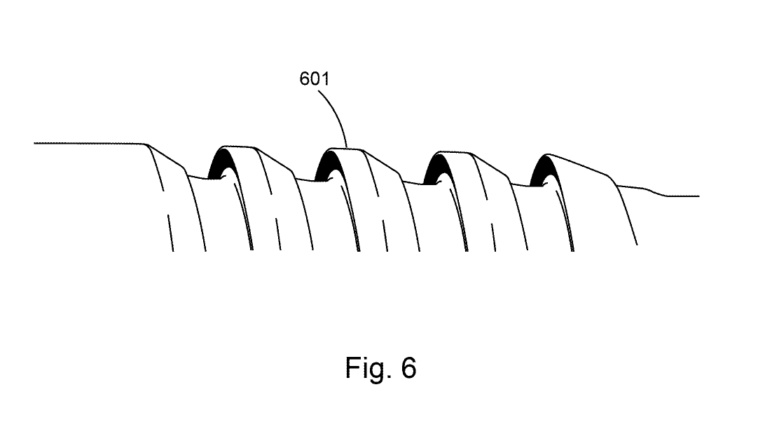

Referring now to FIG. 6, FIG. 6 illustrates external or male thread form 601 in accordance with certain embodiments of the present disclosure.

The thread designs discussed herein may be used in a number of applications. For example, the thread designs discussed herein may be used in drill pipe tool joint connections, production casing connections, drilling riser connections, production riser casing connections, and expandable casing connections.

In certain embodiments, the present disclosure provides a dual shoulder drill pipe connection with a thread profile that provides an improved torque connection designed to push the limits of performance on a double shoulder tool joint connection in torque, tension, and fatigue performance along with rapid make-up speed. In certain embodiments, the multi-surface contact load flanks, trapezoidal thread profile, and dual shoulder design allow the connection to reach increased torques while still maintaining a streamline geometric design. In certain embodiments, the torque capacities may average 10%-150% greater than API connections and 10%-71% greater than most proprietary double shoulder proprietary connections of the same dimensions.

In certain embodiments, the thread designs discussed herein may enhance critical cross-sectional areas, provide additional load flank areas, and provide shoulder contact areas to increase the mechanical properties connections over other thread designs. In certain embodiments, the thread designs discussed herein may take advantage of 135 ksi specified material yield strength (SMYS) to further increase the performance of the connection. In certain embodiments, the thread designs discussed herein may allow for a large root surface area, which reduces peak stresses within the connection, reduces connection stiffness, and increases fatigue resistance.

In certain embodiments, the thread designs discussed herein may takes advantage of multiple thread starts within their design to reduce the amount of revolutions required to make-up the connection to its recommended make-up torque. This turns to make-up throughout the design may vary from 2.1 to 3.2 turns depending on the size of the connection.

In certain embodiments, the thread designs discussed herein may reduce connection stiffness and peak stress. In certain embodiments, the combination of multiple starts, large leads, and the thread form allow the connections to retain smaller outer dimensions and larger internal dimensions creating a reduction in tool joint and connection stiffness from 23%-51% from conventional tool joint connections. In addition, the large radii on the thread roots may aid in decreasing the connection stiffness reducing the peak stresses within the connection associated with bending loads, thus allowing for a long fatigue life.

In certain embodiments, the thread designs discussed herein may increase connection wear life. The connections may have an increased tool joint/drill pipe torsional ratio of 1.2 that allows the connection a significant reduction in OD wear before reaching a premium OD that is equal to that of the pipe body torsional strength at 80% remaining body wall. This may be a ½″ to 1″ outer diameter wear reduction from the connections new outer diameter.

In certain embodiments, the thread design discussed herein may be designed for performance, enhance torque capacity, allow for a rapid make-up torque, allow for an increased wear life, extend fatigue performance, reduce connection stiffness and peak stress, and allow for a larger ID for improved hydraulics.

Although the present invention and its advantages have been described in detail, it should be understood that various changes, substitutions and alternations can be made herein without departing from the spirit and scope of the invention as defined by the following claims.

What is claimed is:

1. A double shoulder threaded tool joint connection comprising:
a pin with external threads formed between a pin external shoulder and a pin internal shoulder, the pin having a nose section between the pin internal shoulder and the pin external threads;
a box with internal threads formed between a box external shoulder and a box internal shoulder;
wherein the internal threads and the external threads are arranged and designed for connection with each other so that the box and the pin are connected with a common center-line and with a primary seal formed by the pin external shoulder forced against the box external shoulder and a secondary seal formed between the pin internal shoulder forced again the box internal shoulder and
wherein the internal threads and the external threads comprise:
stab flanks having stab flank angles of between 20° and 40° measured from the thread axis and
load flanks having first load flank angles of between 60° and 80° measured from the thread axis and second load flank angles of between 100° and 120° measured from the thread axis.

2. The double shoulder threaded tool joint connection of claim 1, wherein the internal and external threads further comprise root surfaces that are parallel with the common center-line.

3. The double shoulder threaded tool joint connection of claim 1, wherein the stab flanks have stab flank angles of 30° measured from the thread axis.

4. The double shoulder threaded tool joint connection of claim 1, wherein the load flanks have first load flank angles of 70° measured from the thread axis and second load flank angles of 110° measured from the thread axis.

5. The double shoulder threaded tool joint connection of claim 1, wherein the internal and external threads further comprise an undercut area.

6. The double shoulder threaded tool join connection of claim 1, wherein the internal and external threads further comprise thread roots and thread crest that are not in engagement.

7. The double shoulder threaded tool join connection of claim 1, further comprising supplemental radii at all corners.

8. A threaded drill pipe comprising:
an external mating shoulder having an external thread form, wherein the external thread form comprises:
an external stab flank having an external stab flank angle of between 20° and 40° measured from the thread axis;
a first external load flank having a first external load flank angle of between 60° and 80° measured from the thread axis; and
a second external load flank having a second external load flank angle of between 100° and 120° measured from the thread axis.

9. The threaded drill pipe of claim 8, wherein the external thread form further comprises a root surface that is parallel with the thread axis.

10. The threaded drill pipe of claim 8, wherein the external stab flank has external stab flank angle of 30° measured from the thread axis.

11. The threaded drill pipe of claim 8, wherein the external load flank has first external load flank angle of 70° measured from the thread axis and second external load flank angle of 110° measured from the thread axis.

12. The threaded drill pipe of claim 8, wherein the external thread form further comprises an undercut area.

13. The threaded drill pipe of claim 8, further comprising supplemental radii at all corners.

14. The threaded drill pipe of claim 8, further comprising:
an internal mating shoulder having an internal thread form, wherein the internal thread form comprises:
an internal stab flank having an internal stab flank angle of between 20° and 40° measured from the thread axis;
a first internal load flank having a first internal load flank angle of between 60° and 80° measured from the thread axis; and
a second internal load flank having a second internal load flank angle of between 100° and 120° measured from the thread axis.

15. The threaded drill pipe of claim 14, wherein the internal stab flank has internal stab flank angle of 30° measured from the thread axis.

16. The threaded drill pipe of claim 14, wherein the internal load flank has first internal load flank angle of 70° measured from the thread axis and second internal load flank angle of 110° measured from the thread axis.

17. The threaded drill pipe of claim 14, wherein the internal thread form and external thread form further comprise thread roots and thread crests that are not in engagement.

18. A thread form comprising:
a thread axis;
a stab flank having a stab flank angle of between 20° and 40° measured from the thread axis;
a first load flank having a first load flank angle of between 60° and 80° measured from the thread axis;
a second load flank having a second load flank angle of between 100° and 120° measured from the thread axis; and
a root surface, wherein the root surface has a flat area that is parallel to a pitch line of the threads.

19. The thread form of claim 18, wherein the thread form further comprises an undercut area.

20. The thread form of claim 18, further comprising supplemental radii at all corners.
